(19) United States
(12) Patent Application Publication
(10) Pub. No.: US 2011/0084872 A1
(43) Pub. Date: Apr. 14, 2011

(54) SIGNAL PROCESSING APPARATUS AND RADAR APPARATUS

(75) Inventor: Masayuki KISHIDA, Kobe-shi (JP)

(73) Assignee: FUJITSU TEN LIMITED, KOBE-SHI (JP)

(21) Appl. No.: 12/897,987

(22) Filed: Oct. 5, 2010

(30) Foreign Application Priority Data
Oct. 8, 2009 (JP) 2009-234369

(51) Int. Cl. G01S 13/42

(52) U.S. Cl. 342/146

(57) ABSTRACT

A signal processing apparatus of a radar transceiver is provided. The radar transceiver transmits a frequency-modulated transmission signal and generates beat signals having a frequency difference between transmitted/received signals for respective receiving antennas. A distance detection section detects relative distances of objects based on frequencies of the beat signals. A phase detection section detects phases of the beat signals. A level storage section stores a first level of the beat signals that corresponds to the first object and a second level of the beat signals that corresponds to the second object when the beat signals are generated corresponding to the plurality of objects, respectively. A phase derivation section derives first and second phases in which the level of a single beat signal coincides with a sum of the first level corresponding to the first phase and the second level corresponding to the second phase on the basis of the wavelength of the beat signal and the relative distances of the plurality of objects, when the signal beat signal is generated corresponding to the plurality of objects. An azimuth angle detection section derives an azimuth angle of the first object based on the difference of the first phase and an azimuth angle of the second object based on the difference of the second phase in a pair of the antennas.

The disclosure of Japanese Patent Application No. 2009-234369 filed on Oct. 8, 2009, including specification, drawings and claims is incorporated herein by reference in its entirety.

### BACKGROUND

The present invention relates to a radar apparatus which detects a relative distance or a relative speed of an object by an FM-CW (Frequency Modulated-Continuous Wave) system and detects an azimuth angle of the object by a phase mono-pulse system, i.e., by using the FM-CW system and the phase mono-pulse system in combination, and a signal processing apparatus thereof, and more particularly to the technology of accurately detecting azimuth angles of respective objects in the case where relative distances and relative speeds of a plurality of objects each coincide with one another.

As a control support means of a vehicle such as an automobile, a vehicle-mounted radar apparatus has been known that detects a relative distance, a relative speed, and an azimuth angle of an object around the vehicle. Patent Documents 1 and 2 describe examples of a vehicle-mounted radar apparatus. An example of a radar apparatus in the related art uses an FM-CW system and a phase mono-pulse system in combination, and detects a relative distance or a relative speed by the FM-CW system and an azimuth angle of the object by the phase mono-pulse system.

The radar apparatus as described above transmits a frequency-modulated radar signal and receives the transmitted signal that is reflected by an object through a pair of receiving antennas. Here, the received signal is received with frequency shift under the influence of a time delay according to a propagation distance from the object to the antenna and Doppler shift. Also, there is a difference in propagation distance between the received signals in the pair of antennas due to the arrival directions of the received signals and a gap between the pair of antennas.

The radar apparatus generates a beat signal having a frequency difference between the transmitted/received signals by mixing the transmitted/received signals through a multiplier, and detects peaks of its frequency spectrum. Here, the detected peaks have frequencies in which the relative distance and the relative speed of the object are reflected. When the peaks are detected by the antennas, a pair of peaks of the same frequency in the pair of antennas has a phase difference according to a difference in propagation distance between the received signals.

Accordingly, the radar apparatus detects the relative distance and the relative speed of the object from the frequencies of the peaks, and detects the azimuth angle from the phase difference between the pair of peaks.

Patent Document 1: Japanese Patent No. 3964362

Patent Document 2: JP-A-2006-317456

However, in a search range around the vehicle, a plurality of objects may exist. In this case, in order to secure the safety of vehicle control, such as collision avoidance and collision countermeasure with the objects, it is necessary to detect a relative distance, a relative speed, and an azimuth angle individually for each object.

Typically, since each object has a different relative distance or relative speed, according to the above-described method, a peak signal of a different frequency is generated for each object, and a peak for each object is detected. However, since the objects are different vehicles moving at high speed, the relative distances and the relative speeds of the plurality of objects may temporarily coincide with each other. In this case, since the received signals having the same frequency are obtained from the plurality of objects, beat signals having the same frequency are generated, and thus a single peak is detected. Also, at this time, since received phases are synthesized between the received signals from the plurality of objects, the phases are synthesized even in the beat signals, and thus the single peak has the synthesized phase (synthetic phase). Also, if the azimuth angles are detected based on the phase difference in the pair of peaks, the azimuth angles of false objects are detected, which are different from the azimuth angles of the actual plurality of objects. Accordingly, if the vehicle control is executed based on the above-described azimuth angles, safety may deteriorate.

### SUMMARY

It is therefore an object of at least one embodiment of the present invention to a radar apparatus using an FM-CW system and a phase mono-pulse system in combination, which can accurately detect azimuth angles of respective objects even if there are a plurality of objects with the same relative distance and the same relative speed.

In order to achieve at least one of the above-described objects, according to a first aspect of the embodiments of the present invention, there is provided a signal processing apparatus of a radar transceiver that transmits a frequency-modulated transmission signal and generates beat signals having a frequency difference between transmitted/received signals for respective receiving antennas, the signal processing apparatus comprising: a distance detection section that detects relative distances of objects based on frequencies of the beat signals; a phase detection section that detects phases of the beat signals; a level storage section that stores a first level of the beat signals that corresponds to the first object and a second level of the beat signals that corresponds to the second object when the beat signals are generated corresponding to the plurality of objects, respectively; a phase derivation section that derives first and second phases in which the level of a single beat signal coincides with a sum of the first level corresponding to the first phase and the second level corresponding to the second phase on the basis of the wavelength of the beat signal and the relative distances of the plurality of objects, when the signal beat signal is generated corresponding to the plurality of objects; and an azimuth angle detection section that derives an azimuth angle of the first object based on the difference of the first phase and an azimuth angle of the second object based on the difference of the second phase in a pair of the antennas.

According to a second aspect of the embodiments of the present invention, there is provided a signal processing method in a signal processing apparatus of a radar transceiver that transmits a frequency-modulated transmission signal and generates beat signals having a frequency difference between transmitted/received signals for respective receiving antennas, the signal processing method comprising: detecting relative distances of objects based on frequencies of the beat signals; detecting phases of the beat signals; storing a first level of the beat signals that corresponds to the first object and a second level of the beat signals that corresponds to the second object when the beat signals are generated corresponding to the plurality of objects, respectively; deriving first and second phases in which the level of a single beat signal coincides with a sum of the first level corresponding to the first phase and the second level corresponding to the second phase on the basis of the wavelength of the beat signal and the relative distances of the plurality of objects, when the signal beat signal is generated corresponding to the plurality of objects; and deriving an azimuth angle of the first object based on the difference of the first phase and an azimuth angle of the second object based on the difference of the second phase in a pair of the antennas.

According to the aspects of the embodiments of the present invention, in the radar apparatus using the FM-CW system and the phase mono-pulse system in combination, it is possible to accurately detect the azimuth angles of respective objects even if there are a plurality of objects with the same relative distance and the same relative speed.

### BRIEF DESCRIPTION OF THE DRAWINGS

In the accompanying drawings:

FIG. 1 is a view illustrating an applied example of a radar apparatus according to an embodiment of the present invention;

FIG. 2 is a view illustrating the brief configuration and the operation principle of a radar apparatus according to an embodiment of the present invention;

FIG. 3 is a block diagram illustrating the configuration of a radar apparatus 10;

FIG. 4 is a diagram illustrating a frequency of a transmitted signal St;

FIGS. 5A and 5B are diagrams illustrating the frequency shift and beat frequencies of received signals Sr1 and Sr2;

FIGS. 6A to 6C are diagrams illustrating frequency spectrums of beat signals Sb1 and Sb2;

FIG. 7 is a flowchart illustrating the operation steps of a radar apparatus 10;

FIGS. 8A to 8F are diagrams illustrating peaks in the case where two objects exist;

FIG. 9 is a view illustrating the brief configuration of a radar transceiver 10a according to a modified example;

FIG. 10 is a diagram illustrating the operation steps of a radar apparatus 10 according to a modified example; and

FIG. 11 is a flowchart illustrating the steps of a phase synthesis reliability process.

### DETAILED DESCRIPTION OF THE EMBODIMENTS

Hereinafter, embodiments of the present invention will be described with reference to the accompanying drawings. However, the present invention is not limited to the embodiments disclosed hereinafter, but extends the scope of the appended claims and their equivalents.

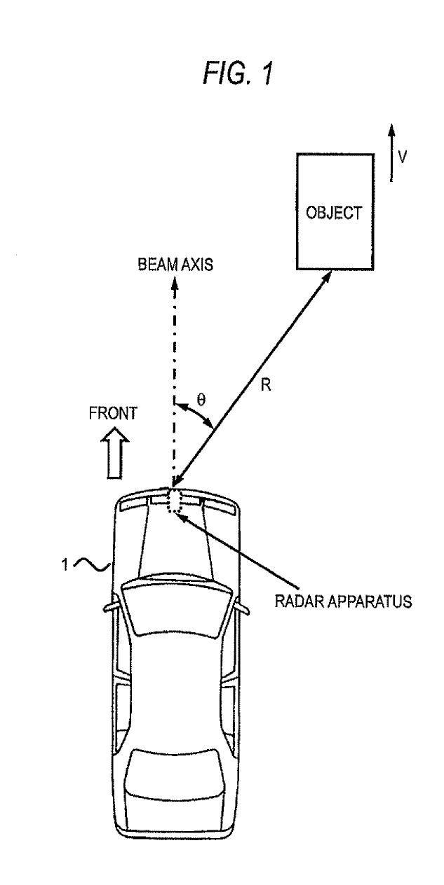

FIG. 1 is a view illustrating an applied example of a radar apparatus according to an embodiment of the present invention. In FIG. 1, a mount position of a radar apparatus that corresponds to a search area thereof is illustrated. For example, in the case of searching the front of a vehicle 1, the radar apparatus is mounted in a bumper or a front grille of a front portion of the vehicle. The radar apparatus detects object information, such as a relative distance R, a relative speed V, and an azimuth angle (e.g. an angle of a center portion of an object against a radar axis) θ of the object that exists in the search area in front of the vehicle 1 by transmitting and receiving radar signals with respect to the search area. Here, the objects may be a preceding vehicle, an oncoming vehicle, a vehicle in a neighboring lane on a road, and the like, and further may be an installation on the side of the road or a pedestrian.

Object information is output to a vehicle control device (not illustrated) of the vehicle 1. This vehicle control device controls the operation of the vehicle 1 by controlling an actuator of the vehicle 1 according to the object information. By doing this, for example, a following driving control for driving while following the preceding vehicle, a collision avoidance control or a collision countermeasure control with another vehicle, installation, a pedestrian, and the like, is performed.

In this case, the mount position of the radar apparatus may be determined in various ways in addition to that as described above. For example, in the case of searching the front side of the vehicle, the radar apparatus is mounted in a fog lamp unit in the front side portion of the vehicle. Also, in the case of searching the rear of the vehicle, the radar apparatus is mounted in a bumper in the rear portion of the vehicle. Further, in the case of searching the rear and side of the vehicle, the radar apparatus is mounted in a tail lamp unit and the like in the rear side portion of the vehicle.

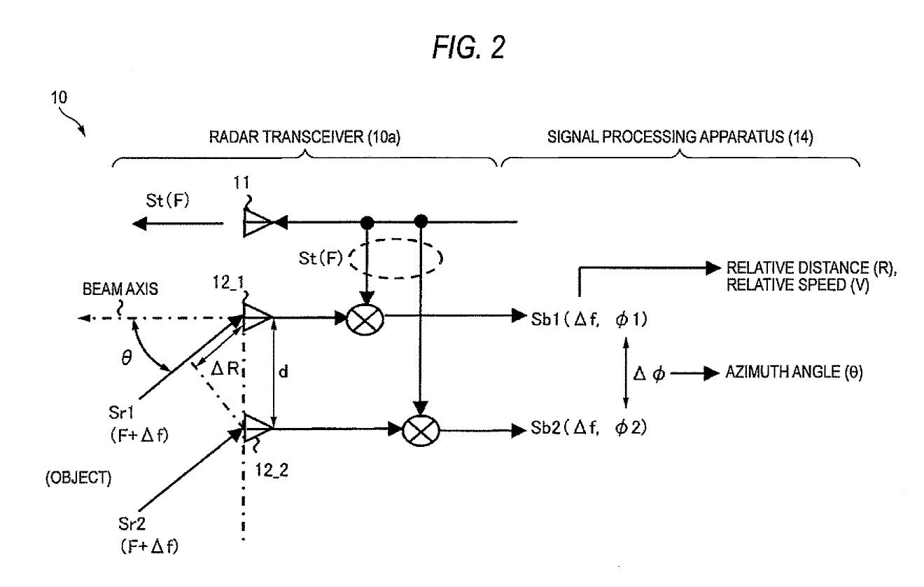

FIG. 2 is a view illustrating the brief configuration and the operation principle of a radar apparatus according to an embodiment of the present invention. In this embodiment, the radar apparatus detects the relative distance or the relative speed of the object by the FM-CW system and detects the azimuth angle of the object by the phase mono-pulse system. As illustrated in FIG. 2, the radar apparatus 10 includes a radar transceiver 10a having a transmitting antenna 11 and a pair of receiving antennas 12_1 and 12_2, and a signal processing apparatus 14 detecting the relative distance R, the relative speed V, and the azimuth angle θ of the object.

The radar transceiver 10a transmits a frequency-modulated transmitted signal St through the antenna 11 so that the frequency ascends/descends in the form of a triangular wave. Here, if it is assumed that the frequency of the transmitted signal St during the transmission is F, the transmitted signal St is received by the antennas 12_1 and 12_2 as received signals Sr1 and Sr2. In this case, the received signals Sr1 and Sr2 receive the frequency shift Δf corresponding to the relative distance R or the relative speed V of the object, and thus the frequency of the received signals becomes F+Δf. Also, if it is assumed that the object exists at an infinite distance in comparison to a distance d between the antennas 12_1 and 12_2, the propagation paths of the received signals Sr1 and Sr2 are considered to be parallel to each other, and thus the received signals Sr1 and Sr2 have a difference ΔR in propagation distance due to the arrival directions against the beam axis, i.e. the azimuth angle θ of the object, and the distance d between the antennas 12_1 and 12_2.

The radar transceiver 10a generates beat signals Sb1 and Sb2 having a beat frequency Δf that corresponds to the frequency difference between the transmitted signal St and the respective received signals Sr1 and Sr2 by multiplying the transmitted signal St and the respective received signals Sr1 and Sr2 in the antennas 12_1 and 12_2. Here, if it is assumed that the beat frequency Δf in a frequency ascending period of the transmitted signal St is α and the beat frequency Δf in a frequency descending period is β, the relative distance R and the relative V of the object are obtained by the following equations, Here, C is the speed of light, ΔF is a width of frequency shift of the transmitted signal St, fm is a frequency of a triangular wave that prescribes the frequency modulation period of the transmitted signal St, and fo is a center frequency of the transmitted signal St.

R=C·(α+β)/(4·ΔA·fm) (1)

V=C·(β−α)/(4·fo) (2)

Although the beat signals Sb1 and Sb2 have the same beat frequency Δf, a phase difference Δφ due to the difference ΔR in propagation distance between the received signals Sr1 and Sr2 occurs between the phase φ1 of the beat signal Sb1 and the phase φ2 of the beat signal Sb2. Accordingly, with respect to the phase difference Δφ and the azimuth angle θ, a relationship as in the following equation is established. Here, λ is a wavelength of the beat signals Sb1 and Sb2.

θ=arcsin(λ·Δφ/(2π·d)) (3)

The signal processing apparatus 14 detects the above-described beat signals Sb1 and Sb2 as the peaks of the frequency spectrum, and detects the relative distance R and the relative speed V from the frequency Δf of either of the beat signals Sb1 or Sb2 by the above-described Equations (1) and (2). Also, the signal processing apparatus 14 detects the phases φ1 and φ2 of the beat signals Sb1 and Sb2, and detects the azimuth angle θ from the phase difference Δφ by the above-described Equation (3).

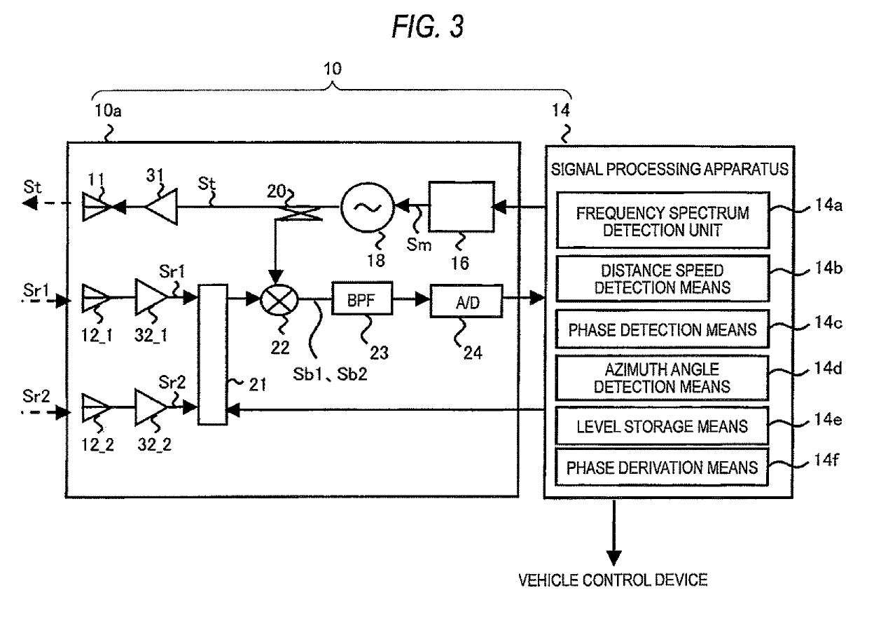

FIG. 3 is a block diagram illustrating the configuration of a radar apparatus 10. In the radar transceiver 10a, a modulation instruction signal generation unit 16 generates a modulation instruction signal Sm for prescribing the frequency of a radar signal. A VCO (Voltage Controlled Oscillator) 18 generates a radar signal (electromagnetic wave) having a frequency corresponding to the voltage of the modulation instruction signal Sm, i.e. the transmitted signal St. The transmitted signal St is amplified by an amplifier 31. The transmitting antenna 11 transmits the amplified transmitted signal St toward the search area.

If the transmitted signal St is reflected by an object, a pair of receiving antennas 12_1 and 12_2 receive the reflected signals as their received signals Sr1 and Sr2. The received signals Sr1 and Sr2 are amplified by respective amplifiers 32-1 and 32-2. A received signal conversion unit 21 outputs the amplified received signals Sr1 and Sr2 to a following circuit in a time division manner in response to a control signal from the signal processing apparatus 14. A mixer 22 multiplies a part of the transmitted signal St, of which the power is divided by a divider 20, by the received signals Sr1 and Sr2 output from a received signal conversion unit 21, respectively, and generates beat signals Sb1 and Sb2 having the beat frequency corresponding to the frequency difference between the transmitted signal and the received signals. The beat signals Sb1 and Sb2 pass through a band pass filter 23 to remove an unnecessary band included therein, and are converted into digital data by an A/D converter 24 to be input to the signal processing apparatus 14.

Here, the frequency modulation of the transmitted signal St will be described. The radar apparatus 10, as described above, detects the relative distance R and the relative speed V of the object by transmitting/receiving the frequency-modulated radar signal in the FM-CW system. In addition, the radar apparatus 10 transmits/receives a radar signal of a constant frequency, and secures the accuracy of the result of detection in the FM-CW system using the result of detection (the detailed method thereof will be described later).

The frequency modulation instruction unit 16 generates a modulation instruction signal Sm of which the voltage ascends/descends in the form of a triangular wave or a modulation instruction signal Sm of constant voltage in response to a control signal from the signal processing apparatus 14, and inputs the modulation instruction signal Sm to the VCO 18. The VCO 18 oscillates the transmitted signal St having a frequency corresponding to the voltage of the input modulation instruction signal Sm in each case.

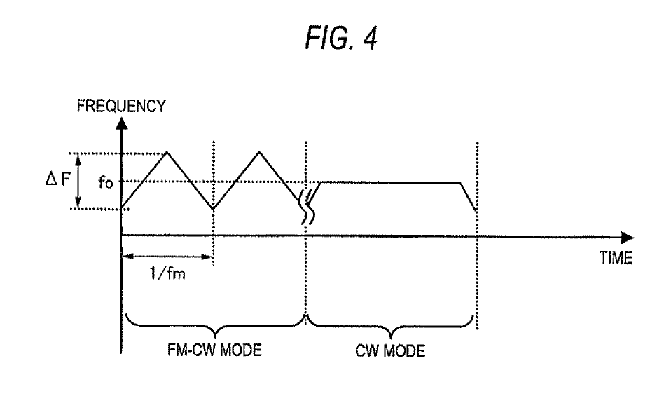

FIG. 4 is a diagram illustrating the frequency of the transmitted signal St. The VCO 18, if the modulation instruction signal Sm in the form of a triangular wave is input thereto, oscillates the transmitted signal St of which the frequency is gradually increased in a straight line in each ascending period of the triangular wave and the frequency is gradually decreased in a straight line in each descending period. Hereinafter, this operation will be referred to as an “FM-CW mode”. In the FM-CW mode, in accordance with the triangular wave of the frequency fm (e.g. 1 KHz), a pair of the frequency ascending period and the frequency descending period is executed once or more. Also, the frequency of the transmitted signal St repeats the ascending and descending in a width ΔF of frequency band (e.g. 100 MHz) around a center frequency fo (e.g. 76.5 GHz)

Also, the VCO 18, if the modulation instruction signal Sm of the constant voltage is input thereto, oscillates the transmitted signal St of the constant frequency. Hereinafter, this operation will be referred to as a “CW mode”. In the CW mode, the frequency of the transmitted signal St is kept constant as the center frequency fo in the FM-CW mode,

The FM-CW mode and the CW mode as described above are controlled by the signal processing apparatus 14 so that they are repeated every several tens of milliseconds.

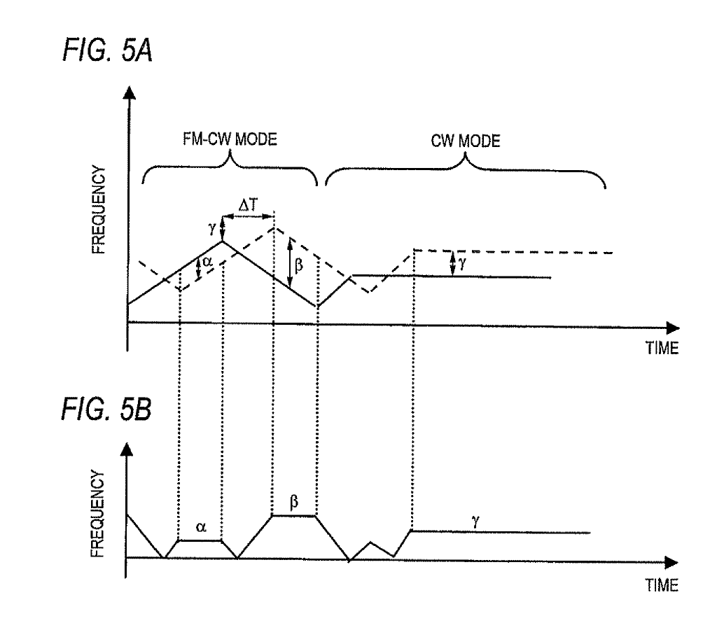

Next, the frequency shift and the beat frequencies of the received signals Sr1 and Sr2 will be described with reference to FIGS. 5A and 5B.

FIG. 5A shows the change of the frequency (vertical axis) of the transmitted signal St and the received signal Sr1 or Sr2 over time (horizontal axis). The frequency change of the transmitted signal St indicated by a solid line is the same as that illustrated in FIG. 4. On the other hand, the frequency of the received signal Sr1 or Sr2 indicated by a dashed line has a time delay ΔT due to the relative distance R of the object and is shifted for Doppler shift γ according to the relative speed V of the object, in comparison to the frequency of the transmitted signal St. As a result, a frequency difference α and a frequency difference β occur in the frequency ascending period and in the frequency descending period, respectively, between the transmitted signal St and the received signals Sr1 and Sr2 in the FM-CW mode. Also, a frequency difference γ that corresponds to the Doppler shift occurs between the transmitted signal St and the received signals Sr1 and Sr2 in the CW mode.

FIG. 5B shows the beat frequencies (vertical axis) of the beat signals Sb1 and Sb2 generated in the FM-CW mode and the CW mode over the time (horizontal axis). By the frequency shift of the received signals Sr1 and Sr2 as shown in FIG. 5A, the beat frequencies in the FM-CW mode become the frequency α in the frequency ascending period and the frequency β in the frequency descending period. In this case, the beat frequency in the CW system becomes the frequency γ.

Here, between the beat frequencies α and β in the FM-CW mode, the relative distance R of the object, and the relative speed V of the object, the above-described Equations (1) and (2) are realized.

On the other hand, between the beat frequency γ in the CW mode and the relative speed V of the object, the relationship indicated in the following equation is established. Here, C is the speed of light.

V=(γ·C)/[2 (fo−γ)] (4)

Referring again to FIG. 3, the configuration of the signal processing apparatus 14 will be described. The signal processing apparatus 14 includes a frequency spectrum detection unit 14a that detects the frequency spectrum by performing FFT (Fast Fourier Transform) of the beat signals Sb1 and Sb2. The frequency spectrum detection unit 14a is composed of an operation circuit such as a DSP.

Also, the signal processing apparatus 14 includes a ROM in which various kinds of control programs and processing programs are stored, a CPU that executes the control programs and the processing programs read from the ROM, and a microcomputer provided with a RAM that temporarily maintains operation data. The control of the modulated signal generation unit 16 and the received signal conversion unit 21 and the process by the distance speed detection means 14b, the phase detection means 14c, the azimuth angle detection means 14d, the level storage means 14e, and the phase derivation means 14f are realized by the control program or the processing program corresponding to the steps of the processes and the CPU that executes the programs.

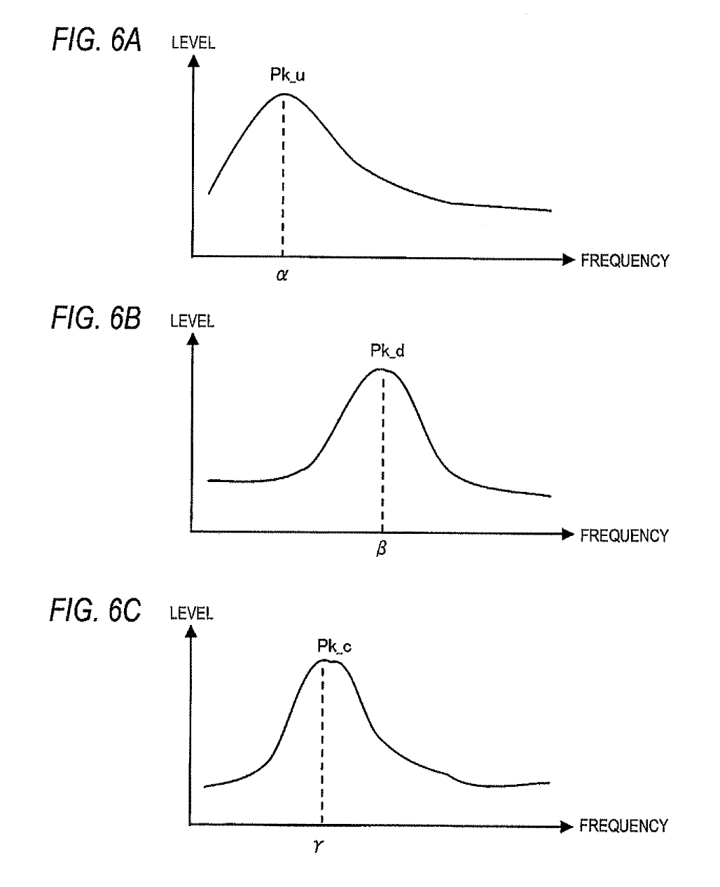

FIGS. 6A to 6C are diagrams illustrating the frequency spectrums of the beat signals Sb1 and Sb2 detected by the frequency spectrum detection unit 14a. As examples of the beat signals Sb1 and Sb2 as illustrated in FIG. 5B, FIGS. 6A, 6B, and 6C show the frequency spectrum in the frequency ascending period in the FM-CW mode, the frequency spectrum in the frequency descending period in the FM-CW mode, and the frequency spectrum in the CW mode, respectively.

Here, since the level of the received signals Sr1 and Sr2 from the object is relatively higher than the received signals by the reflection on a road surface and so on, peaks are formed in the frequency spectrums of the beat signals Sb1 and Sb2. Accordingly, if one object exists in the search area, in the FM-CW mode, a peak P_u of the beat frequency a as shown in FIG. 6A is formed in the frequency ascending period, and a peak Pk_d of the beat frequency β as shown in FIG. 6B is formed in the frequency descending period, Also, in the CW mode, a peak Pk_c of the beat frequency γ as shown in FIG. 6C is formed. The signal processing apparatus 14 detects the peaks Pk_u, Pk_d, and Pk_c that form the maximum values, for example, by performing binary approximation of the respective frequency spectrums.

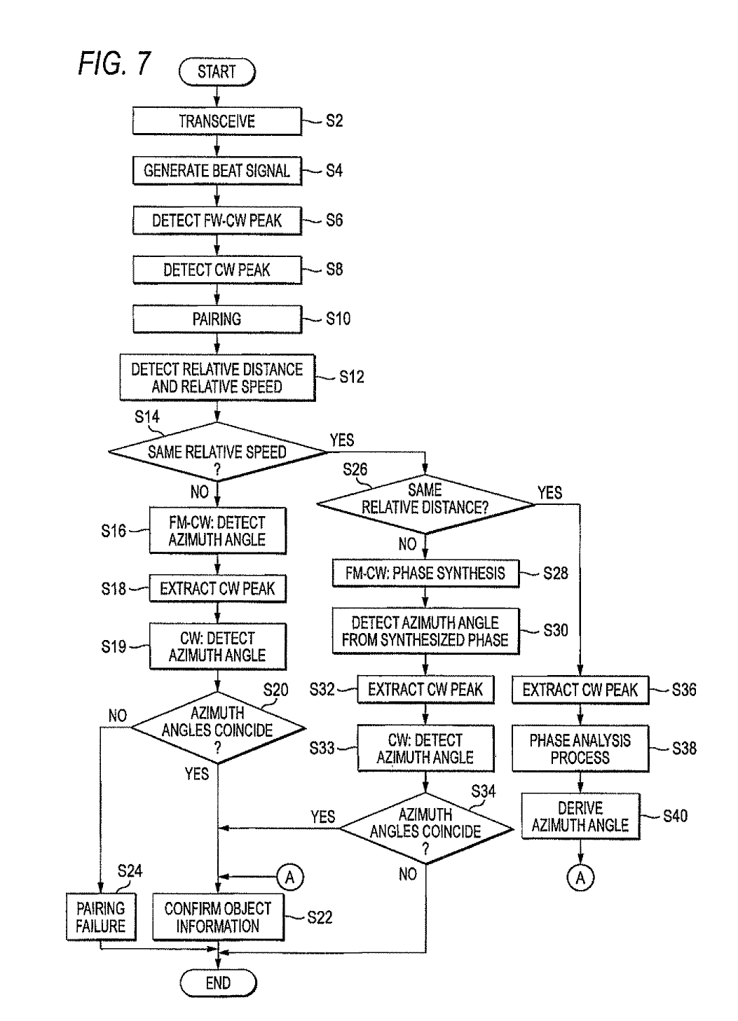

FIG. 7 is a flowchart illustrating the operation steps of the radar apparatus 10. Here, for example, if it is assumed that a pair of an FM-CW mode and a CW mode constitute one processing cycle, the steps as shown in FIG. 7 are performed once every processing cycle.

The radar transceiver 10a performs transmission of the transmitted signal St and reception of the received signals Sr1 and Sr2 in the FM-CW mode and the CW mode in response to the control signal from the signal processing apparatus 14 in step S2, and generates the beat signals Sb1 and Sb2 in step S4.

In step S6, the frequency spectrum detection unit 14a detects the frequency spectrums of the beat signals Sb1 and Sb2 in the FM-CW mode, and the signal processing apparatus 14 detects the peak of the frequency spectrum. Hereinafter, for convenience in explanation, the peak detected from the beat signal in the FM-CW mode will be referred to as an “FM-CW peak”. In step S8, the frequency spectrum detection unit 14a detects the frequency spectrums of the beat signals Sb1 and Sb2 in the CW mode. Also, the signal processing apparatus 14 detects the peak of the frequency spectrum. Hereinafter, for convenience in explanation, the peak detected from the beat signal in the CW mode will be referred to as a “CW peak”.

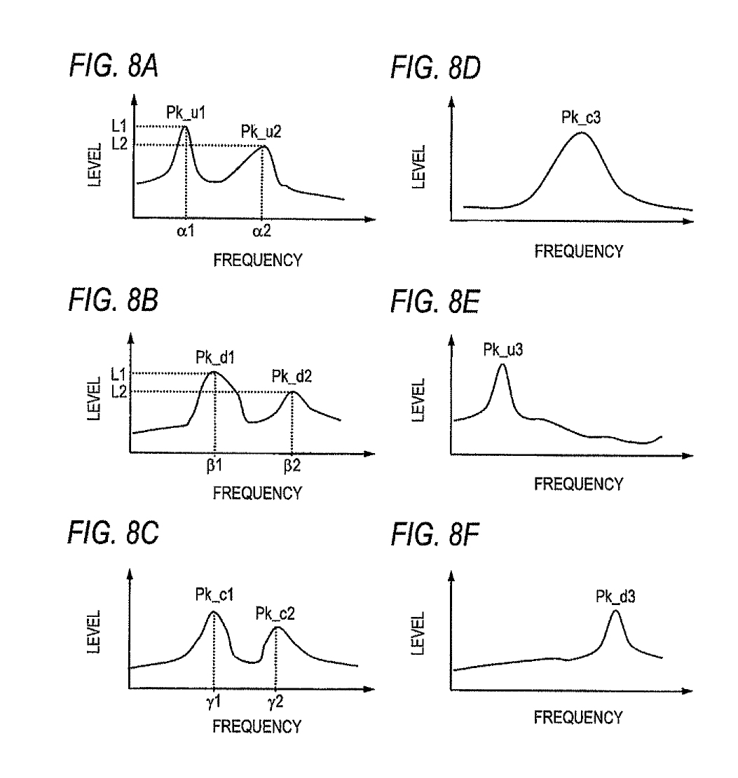

Typically, a plurality of objects exists in a search area. Accordingly, a case where a plurality of objects exists will be exemplified. However, for simplification of explanation, it is exemplified that two objects exist. Hereinafter, peaks in the case where two objects exist will be described using FIGS. 8A to 8F.

FIGS. 8A and 8B show a case where two FM-CW peaks are detected. In this case, at least one of the relative distance and a relative speed of the two objects differs, and the beat signals Sb1 and Sb2 obtained from the respective objects have beat frequencies different from each other. Accordingly, in the frequency ascending period, as shown in FIG. 8A, an FM-CW peak Pk_u1 of the beat frequency α1 and an FM-CW peak Pk_u2 of the beat frequency α2 are detected, and in the frequency descending period, as shown in FIG. 8B, an FM-CW peak Pk_d1 of the beat frequency β1 and an FM-CW peak Pk_d2 of the beat frequency β2 are detected.

Referring again to FIG. 7, in step S10, the signal processing apparatus 14 performs pairing of the FM-CW peak in the frequency ascending period and the FM-CW peak in the frequency descending period. In FIGS. 8A and 8B, the signal processing apparatus 14 performs pairing of the peaks which have coinciding levels with each other in the frequency ascending period and the frequency descending period, respectively. That is, the FM-CW peaks Pk_u1 and Pk_d1 of level L1 are paired, and the FM-CW peaks Pk_u2 and Pk_d2 of level L2 are paired.

In step S12, a distance speed detection means 14b detects the relative speeds and the relative distances of the respective objects by the above-described Equations (1) and (2), based on the beat frequencies of the paired FM-CW peak pairs, i.e. the beat frequency α1 of the FM-CW peak Pk_u1 and the beat frequency β1 of the FM-CW peak Pk_d1, and the beat frequency α2 of the FM-CW peak Pk_u2 and the beat frequency β2 of the FM-CW peak Pk_d2. Here, the distance speed detection means 14b corresponds to the “distance detection means” in the present invention.

As describe above, the relative speeds and the relative distances of the respective objects are detected based on the FM-CW peaks Pk_u1, Pk_u2, Pk_d1, and Pk_d2. Then, step S14 and the subsequent steps are performed to confirm the accuracy of the result of detection in the FM-CW mode.

In step S14, the signal processing apparatus 14 judges whether or not the relative speeds of the two objects are the same. If the judgment result is “No”, the processing proceeds to step S16.

In step S16, the phase detection means 14c detects each of the phases of the FM-CW peaks Pk_u1, Pk_u2, Pk_d1, and Pk_d2, and the azimuth angle detection means 14d detects the azimuth angles based on the phase difference between the respective peaks in the antennas 12_1 and 12_2. In this case, among the paired FM-CW peaks, the azimuth angle may be detected from the phase difference between the FM-CW peaks Pk_u1 and Pk_u2 in the frequency ascending period or from the phase difference between the FM-CW peaks Pk_d1 and Pk_d2 in the frequency descending period. Or, the azimuth angle may be detected from an average of the obtained phase differences.

In step S18, the signal processing apparatus 14 extracts the CW peaks so that the respective relative speeds can be detected on the basis of the relative speeds of the two objects detected in the FM-CW mode. In the above-described Equation (4), the beat frequency is extracted by specifying the relative speeds. Accordingly, the CW peaks corresponding to the derived beat frequencies are extracted. Here, as illustrated in FIG. 8C, if the relative speeds of the two objects are different from each other, the CW peak Pk_c1 having the beat frequency γ1 and the CW peak Pk_c2 having the beat frequency γ2 are detected, and the CW peaks Pk_c1 and Pk_c2 correspond to one of the relative distances of the two objects detected in the FM-CW mode.

In step S19, the phase detection means 14c detects the respective phases of the extracted CW peaks, and the azimuth angle detection means 14d detects the azimuth angle based on the difference between the phases detected by the azimuth angle detection means in the antennas 12_1 and 12_2. At this time, the method of detecting the azimuth angle based on the CW peaks is described with reference to FIG. 2. In this case, the beat frequency Δf of the beat signals Sb1 and Sb2 in FIG. 2 corresponds to the Doppler frequency.

In step S20, the signal processing apparatus 14 confirms whether or not the azimuth angle detected based on the FM-CW peaks coincides with the azimuth angle detected based on the CW peaks corresponding to the relative speeds. Here, since the CW peaks Pk_c1 and Pk_c2 are detected for the respective objects and the received phases are not synthesized, the azimuth angle obtained based on the CW peaks Pk_c1 and Pk_c2 is used as the determination standard for an accurate azimuth angle.

Since the judgment result is “Yes” when the azimuth angles coincide with each other, the process proceeds to step S22, and the signal processing apparatus 14 confirms the detected relative distance, the relative speed, and the azimuth angle as object information and ends the process. Also, in the case where the history of the confirmed object information is accessed multiple times, it is output to the vehicle control device.

On the other hand, in step S20, if the azimuth angle based on the FM-CW peaks is different from the azimuth angle based on the CW peaks, it is judged that wrong pairing is performed in step S10. For example, if the levels of the respective FM-CW peaks are approximately equal to each other in the frequency ascending period and the frequency descending period, wrong pairing may be performed. Accordingly, in this case, since the judgment result is “No”, the process proceeds to step S24, and the signal processing apparatus 14 judges that the pairing has failed, and ends the process without confirming the object information.

Next, a case where the relative speeds of the two objects are equal to each other will be described. In this case, the judgment result in step S14 is “Yes”, and thus the processing proceeds to step S26.

In step S26, the signal processing apparatus 14 confirms whether the relative distances of the two objects are equal to each other. If the result of judgment is “No”, the processing proceeds to step S28.

In step S28, the phase derivation means 14f derives the synthesized phase by synthesizing the phases of the FM-CW peaks. In the examples of FIGS. 8A and 8B, the phases of the FM-CW peaks Pk_u1 and Pk_u2 in the frequency ascending period are detected, and their synthesized phase is derived. Also, in step S30, the azimuth angle detection means 14d detects the azimuth angle from the synthesized phase. Here, a false azimuth angle is detected from the synthesized phase.

In step S32, similarly to step S18, the signal processing apparatus 14 extracts the CW peaks for detecting the relative speeds on the basis of the FM-CW peaks. In this case, since the relative speeds of the two objects are equal to each other, the phases of the beat signals of the same frequency are synthesized in the CW mode. Accordingly, as illustrated in FIG. 8D, a single CW peak Pk_c3 having the synthesized phase is detected.

In step S33, the azimuth angle detection means 14d detects the azimuth angles based on the phases in the CW peak Pk_c3. In this case, since the phase is the synthesized phase as described above, a false azimuth angle is detected.

In step S34, the signal processing apparatus 14 confirms whether or not the azimuth angle based on the synthesized phase of the FM-CW peak detected in step S30 coincides with the azimuth angle based on the synthesized phase of the CW peak detected in step S33. If the result of judgment is “Yes”, i.e. if the false azimuth angles based on the synthesized phases coincide with each other, it is confirmed that at least the pairing of the FM-CW peaks is accurately performed. Accordingly, the processing proceeds to step S22, and the signal processing apparatus 14 confirms the object information.

On the other hand, if the result of judgment is “No”, it is judged that the pairing has failed, and the processing is ended without confirming the object information. Alternately, a step in a modified example to be described later is performed.

Next, a case where any of the relative distances and the relative speeds of the two objects are equal to each other will be described. In this case, since the received signals having the same frequency are obtained from the two objects, beat signals having the same beat frequency are generated in the FM-CW mode. Also, since the phases of the received signals having the same frequency are synthesized, the phases are synthesized even in the beat signals. Accordingly, in the frequency ascending period, as shown in FIG. 8E, a single FM-CW peak Pk-u3 having the synthesized phase is detected, and in the frequency descending period, as shown in FIG. 8F, a single FM-CW peak Pk_d3 having the synthesized phase is detected.

In this case, it may be impossible to judge whether or not the single FM-CW peak Pk_u3 or Pk-d3 has been detected due to a single object existing in the FM-CW mode or whether the single FM-CW peak Pk_u3 or Pk_d3 has been detected by the synthesis of two beat signals. Accordingly, for example, it may be possible to judge that the relative distances and the relative speeds of the two objects coincide with each other when the single FM-CW peak is detected. Or, in the case where the number of objects confirmed by the object information is decreased in the history of the object information, the probability that the received signals have been synthesized is high, and thus it may be judged that the relative distances and the relative speeds of the two objects coincide with each other.

If the judgment result in step S26 is “Yes”, the processing proceeds to step S36, and the signal processing apparatus 14 detects the CW peaks for detecting the relative speeds on the basis of the FM-CW peaks Pk_u3 and Pk_d3 in the same manner as in step S18 or S32. In this case, a single CW peak Pk_c3 having the synthesized phase as shown in FIG. 8D is detected.

Then, in step S38, the phase derivation means 14f performs the process of analyzing the synthesized phase of the FM-CW peak Pk_u3 or Pk_d3. Specifically, the following operation is performed.

First, if it is assumed that the level of the FM-CW peak Pk_u3 or Pk_d3 is Pf, the detected synthesized phase is φf, the detected relative distance (here, the same relative distance) of the two objects is R, the wavelength of the beat signals Sb1 and Sb2 (here, any one of the FM-CW peaks Pk_u3 and Pk_d3) is λ, the levels of the FM-CW peaks corresponding to the two objects are Pf1 and Pf2, and the phases of the FM-CW peaks to be obtained from the two objects are φ1 and φ2, the following relationship is established.

Pf·sin(2π·λ/R+φf)'Pf1·sin(2π·λ/R+φ1)+Pf2·sin(2π·λ/R+φ2) (5)

The following process is performed to derive φ1 and φ2 in Equation (5). Here, if it is assumed that the level ratio of the FM-CW peaks corresponding to two objects is α, the relationship becomes Pf2=α·Pf1, and thus Equation (5) can be modified into the following.

Pf·sin(2π·λ/R+φf)=Pf1·sin(2π·λ/R+φ1)+α·Pf1·sin(2π·λ/R+φ2) (6)

Then, if it is assumed that the level of the CW peak is Pc, the synthesized phase is φc, and the levels of the CW peaks corresponding to the two objects are Pc1 and Pc2, the following relationship is established.

Pc·sin(2π·λ/R+φc)=Pc1·sin(2π·λ/R+φ1)+Pc2·sin(2π·λ/R+φ2) (7)

Here, by performing simulations by the known radar equation based on the hardware characteristic of the radar transceiver 10a or by experiments, the correlation between the level of the FM-CW peak and the level of the CW peak obtained from the same object can be obtained. If it is assumed that the correlation coefficient is β and the relationship becomes β·Pf=Pc, the Equation (7) can be modified into the following.

$$β \cdot Pf \cdot sin ( 2 π \cdot λ / R + φ c ) = β \cdot Pf 1 \cdot sin ( 2 π \cdot λ / R + φ1 ) + β \cdot Pf 2 \cdot sin ( 2 π \cdot λ / R + φ2 ) = β \cdot Pf 1 \cdot sin ( 2 π \cdot λ / R + φ1 ) + β \cdot α \cdot Pf 1 \cdot sin ( 2 π \cdot λ / R + φ2 ) \qquad ( 8 )$$

Here, for the level of the FM-CW peak when the received signals from the two objects are synthesized, if it is considered that a sum of the levels of the FM-CW peaks detected for each object, the level of FM-CW peaks is Pf=Pf1+Pf2, and thus the phases φ1 and φ2 can be derived from Equations (6) and (8). For example, the Equations (6) and (8) can be modified into the following.

Equation (6)

(Pf1+Pf2)·sin(2π·λ/R+φf)=Pf1·sin(2π·λ/R+φ1)+α·Pf1·sin(2π·λ/R+φ2) (9)

Equation (8)

β·(Pf1+Pf2)·sin(2π·λ/R+φc)=β·Pf1·sin(2π·λ/R+ 1)+β·α·Pf1·sin(2π·λ/R+φ2) (10)

Here, as the levels Pf1 and Pf2 of the FM-CW peaks corresponding to the two objects, it is possible to extract the two objects having very close relative distances or relative speeds among the object information detected in the past and to use the levels of the FM-CW peaks corresponding to the extracted objects, respectively. Specifically, if at least one of the relative distances and the relative speeds of the two objects differs when two peaks are detected from the two objects, the level storage means 14e stores the levels of the FM-CW peaks in a RAM provided inside the signal processing apparatus 14 the levels of FM-CW peaks of the objects which were extracted as having the very close relative distances or relative speed. This process, for example, may be performed for each processing cycle. Also, the phase derivation means 14f reads this. By doing this, in Equations (9) and (10), Pf1, Pf2, λ, R, φf, α, β, and φc are all known values and the unknown numbers are φ1 and φ2, and thus φ1 and φ2 can be derived by solving the Equations (9) and (10).

The phase derivation means 14f derives the synthesized phase φf in the single FM-CW peak by performing the above-described operation, and derives the phases φ1 and φ2 of the beat signals obtained from the two objects. In step S40, the azimuth angle detection means 14d derives the azimuth angles of the two objects based on the phase difference between the derived phases φ1 and φ2 in the antennas 12_1 and 12_2.

According to the above-described steps, even in the case where the relative distances and the relative speeds of the two objects are equal to each other and the beat signals are synthesized, it is possible to detect the azimuth angles of the respective objects accurately.

Next, a modified example of the above-described embodiment will be described.

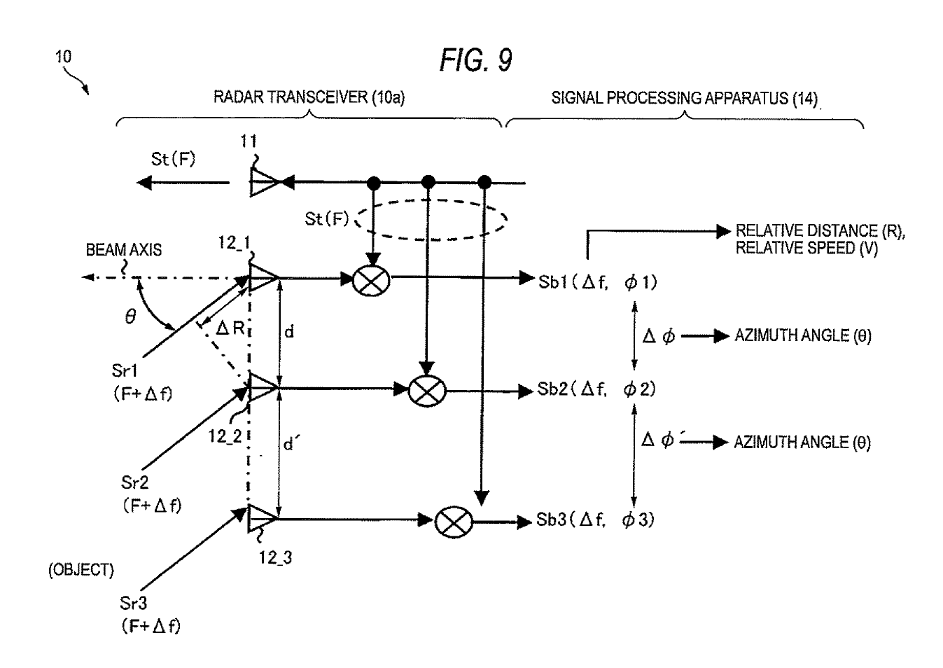

FIG. 9 is a diagram illustrating the brief configuration of the radar transceiver 10a according to the modified example. Here, the radar transceiver 10a includes a receiving antenna 12_3 for receiving a received signal Sr3 in addition to the configuration as illustrated in FIG. 2, and generates a beat signal Sb3 from the received signals Sr3. Also, the signal processing apparatus 14, in the above-described method as shown in FIG. 2, detects the azimuth angle θ from the phase difference Δφ′ between the phase φ2 of the beat signal Sb2 and the phase φ3 of the beat signal Sb3. Here, the distance d between the antennas 12_1 and 12_2 is different from the distance d′ between the antennas 12_2 and 12_3, and the azimuth angle θ is detected using detected values that are different from those in the case where the azimuth angle θ is detected based on the beat signals Sb1 and Sb2. Accordingly, by comparing the two results, the accuracy of the azimuth angle θ can be improved.

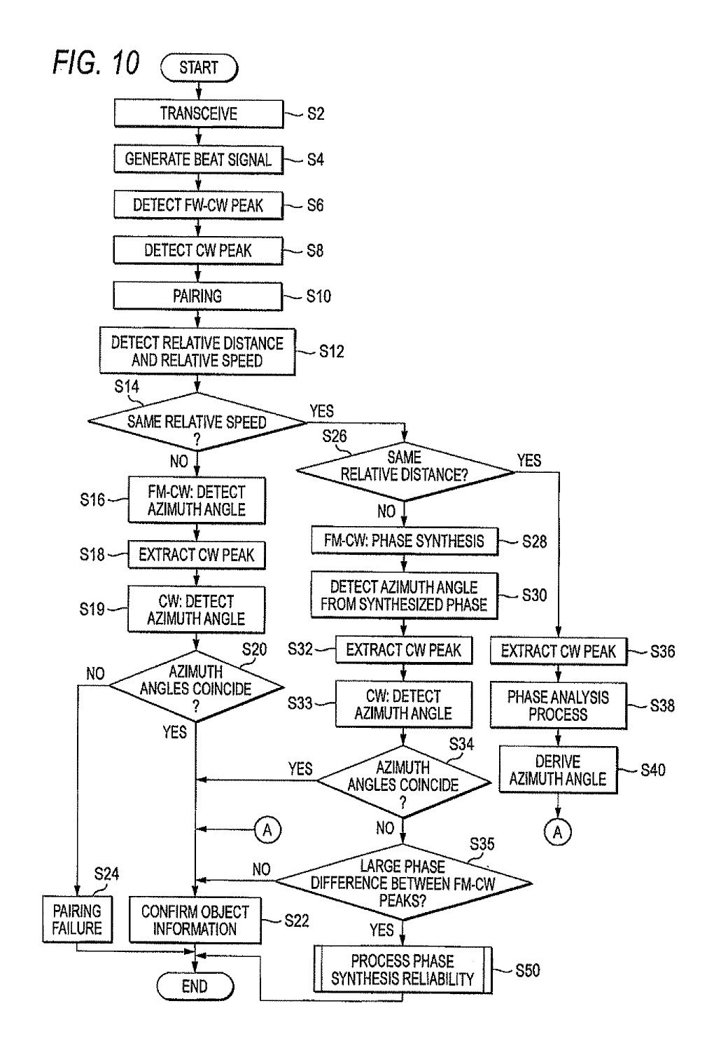

FIG. 10 is a diagram illustrating the operation steps of a radar apparatus 10 according to a modified example. The operation steps of FIG. 10 are different from those of FIG. 7 on the point that step S35 follows step S34 and step 50 is additionally provided.

Referring to FIG. 10, in step S34, it is confirmed whether or not the azimuth angle based on the synthesized phase of the FM-CW peak detected in step S30 coincides with the azimuth angle based on the synthesized phase of the CW peak detected in step S33, and if the judgment result is “No”, the processing proceeds to step S35.

In step S35, the signal processing apparatus 14 confirms whether or not a difference between the phase difference Δφ of the FM-CW peaks in the antennas 12_1 and 12_2 and the phase difference Δφ′ in the antennas 12_2 and 12_3 is large, for example, by comparing the difference with a preset threshold value. Here, if the judgment result is “No”, i.e. if the difference is small, it is confirmed that at least the pairing of the FM-CW peaks is accurately performed. Accordingly, the processing proceeds to step S22, and the signal processing apparatus 14 confirms the object information.

On the other hand, if the judgment result is “No”, it is judged that the pairing has failed, and the proceeding proceeds to step S50, and the phase synthesis reliability process is performed.

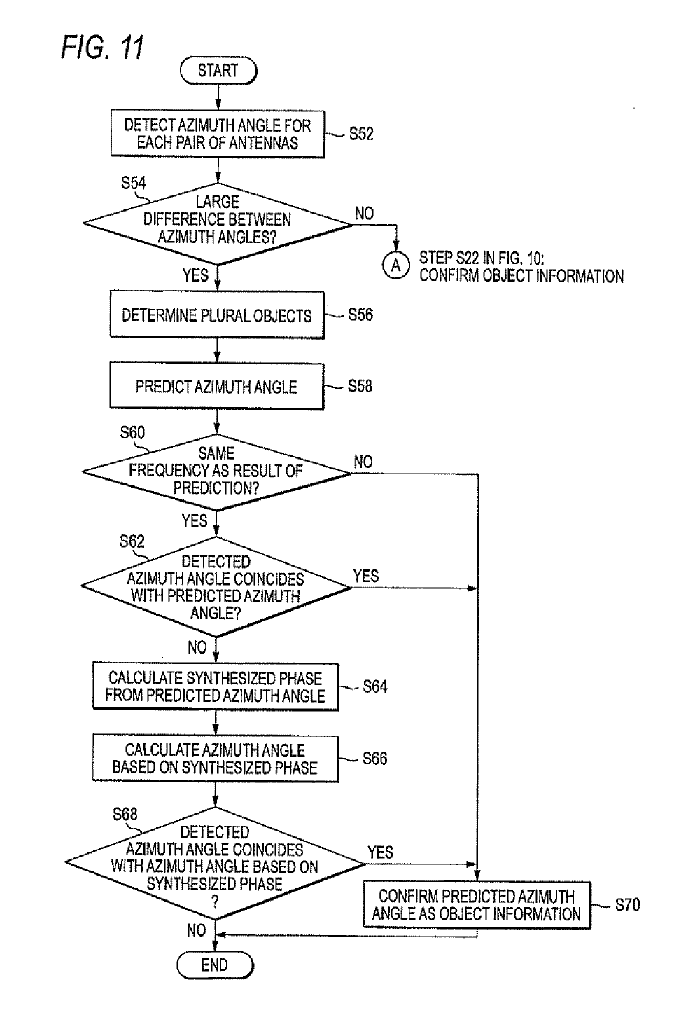

FIG. 11 is a flowchart illustrating the steps of the phase synthesis reliability process. The steps in FIG. 11 correspond to a subroutine of step S50 in FIG. 10.

In step S52, the azimuth angle detection means 14d detects the azimuth angles for each of the antenna pairs 12_1, 12_2, 12_2 and 12_3. Then, in step S54, the signal processing apparatus 14 confirms whether or not the difference between the detected azimuth angles is large, for example, if the detected azimuth angle is within a preset error range. If the difference is small, the judgment result becomes “No”, and thus the processing proceeds to step S22 in FIG. 10 to confirm the object information. On the other hand, if the difference is large, the judgment result becomes “Yes”, and the processing proceeds to step S56.

The signal processing apparatus 14 judges that a plurality of objects exists in step S56, and predicts the azimuth angles of the respective objects at the present point in time based on the object information of the plurality of objects detected in the past. For example, the signal processing apparatus 14 predicts the positions of the objects at the present point in time, based on the change over time of the positions of the objects derived from the relative distances and the azimuth angles and the relative speeds, and derives the azimuth angle corresponding to the predicted position as a predicted value.

In step S60, the distance speed detection means 14b derives the relative speeds and the relative distances of the objects corresponding to the predicted azimuth angles of the plurality of objects. In this case, for example, by making the relative speeds constant, the processing is simplified. Also, the frequencies corresponding to the derived relative speeds and the relative distances are predicted, and it is confirmed whether or not the beat signals having the same frequency are generated at the present processing cycle.

Here, if the judgment result is “No”, the processing proceeds to step S70. When the beat signals having the same frequency are not generated, the phases of the beat signals are synthesized through the synthesis of the received signals, and there is a high probability that the azimuth angle detected in step S52 is a false azimuth angle based on the synthesized phase. Accordingly, in step S70, the signal processing apparatus 14 confirms the azimuth angle predicted in step S58 as the object information without confirming the detected azimuth angle as the object information.

On the other hand, if the judgment result in step S60 is “Yes”, the processing proceeds to step S62. In step S62, the signal processing apparatus 14 confirms whether or not the azimuth angle detected in step S52 coincides with the azimuth angle predicted in step S58 (including a case where the detected azimuth angle is within a certain preset error range). If the detected azimuth angle coincides with the predicted azimuth angle, the judgment result becomes “Yes”, and thus the processing proceeds to step S70 to confirm the predicted azimuth angle as the object information. If the detected azimuth angle does not coincide with the predicted azimuth angle, the judgment result becomes “No”, and the processing proceeds to step S64.

In step S64, the phase derivation means 14f estimates the phases of the beat signals for each object based on the predicted azimuth angles, the detected relative distances, and the frequencies of the beat signals. Specifically, the phase derivation means 14f performs the operation that solves the above-described Equation (5). At that time, two objects having the close relative distances or relative speeds are extracted from the object information detected in the past, and it is assumed that the corresponding levels of the FM-CW peaks are Pf1 and Pf2, the level of the detected FM-CW peak is Pf, the phase is φf, the detected relative distance is R, the wavelength of the beat signal is λ, and the phases of the FM-CW peaks to be obtained from the two objects are φ1 and φ2. Also, using the estimated phases, the synthesized phase of the beat signals is derived.

In step S66, the azimuth angle detection means 14d derives the azimuth angles based on the derived synthesized phase. Here, there is a high probability that the azimuth angle is a false azimuth angle.

In step S68, the signal processing apparatus 14 confirms whether or not the azimuth angle detected in step S52 coincides with the azimuth angle derived in step S66 (including a case where the detected azimuth angle is within a certain preset error range). If the detected azimuth angle coincides with the predicted azimuth angle, the judgment result becomes “Yes”, and thus it is confirmed that the azimuth angle detected in step S52 is a false azimuth angle based on the phase synthesis. In this case, the processing proceeds to step S70, and the predicted azimuth angle is confirmed as the object information. If the detected azimuth angle does not coincide with the predicted azimuth angle, the judgment result becomes “No”, and the processing is ended without confirming the object information.

According to the steps as described above, even in the case where the relative distances and the relative speeds of the two objects are equal to each other and the beat signals are synthesized, confirmation of a false azimuth angle based on the synthesized azimuth angle as the object information can be avoided, and an azimuth angle that is estimated more accurately, based on the history of the object information detected in the past, can be confirmed as the object information. In this case, the phase synthesis reliability process as illustrated in FIG. 11 is described in JP-A-2010-096589 (Japanese Patent Application No. 2008-266504) filed on Oct. 15, 2008 by the inventors of the present invention.

As described above, for convenience in understanding, it is exemplified that two objects exist. However, even in the case where three or more objects exist, the present invention can be adopted.

As described above, in the radar apparatus using the FM-CW system and the phase mono-pulse system in combination according to the present invention, it is possible to accurately detect the azimuth angles of the plurality of objects even if there are a plurality of objects with the same relative distance and the same relative speed.

What is claimed is:

1. A signal processing apparatus of a radar transceiver that transmits a frequency-modulated transmission signal and generates beat signals having a frequency difference between transmitted/received signals for respective receiving antennas, the signal processing apparatus comprising:
a distance detection section that detects relative distances of objects based on frequencies of the beat signals;
a phase detection section that detects phases of the beat signals;
a level storage section that stores a first level of the beat signals that corresponds to the first object and a second level of the beat signals that corresponds to the second object when the beat signals are generated corresponding to the plurality of objects, respectively;
a phase derivation section that derives first and second phases in which the level of a single beat signal coincides with a sum of the first level corresponding to the first phase and the second level corresponding to the second phase on the basis of the wavelength of the beat signal and the relative distances of the plurality of objects, when the signal beat signal is generated corresponding to the plurality of objects; and
an azimuth angle detection section that derives an azimuth angle of the first object based on the difference of the first phase and an azimuth angle of the second object based on the difference of the second phase in a pair of the antennas.

2. The signal processing apparatus as set forth in claim 1,
wherein the radar transceiver generates beat signals having a frequency difference between the transmitted/received signals for the respective receiving antennas by further transmitting a transmission signal of a predetermined frequency, and
the phase derivation section derives the first and second phases, when a first single beat signal based on the frequency-modulated transmission signal is generated and a second single beat signal based on the transmission signal of the predetermined frequency is generated corresponding to the plurality of objects, on the basis of a wavelength of the first beat signal, the relative distances of the plurality of objects, and a level ratio of the first and second beat signals.

3. A radar apparatus including the signal processing apparatus as set forth in claim 1.

4. The radar apparatus as set forth in claim 3, wherein the radar apparatus is mounted on a vehicle and detects relative distances and azimuth angles of objects around the vehicle.

5. A signal processing method in a signal processing apparatus of a radar transceiver that transmits a frequency-modulated transmission signal and generates beat signals having a frequency difference between transmitted/received signals for respective receiving antennas, the signal processing method comprising:
detecting relative distances of objects based on frequencies of the beat signals;
detecting phases of the beat signals;
storing a first level of the beat signals that corresponds to the first object and a second level of the beat signals that corresponds to the second object when the beat signals are generated corresponding to the plurality of objects, respectively;
deriving first and second phases in which the level of a single beat signal coincides with a sum of the first level corresponding to the first phase and the second level corresponding to the second phase on the basis of the wavelength of the beat signal and the relative distances of the plurality of objects, when the signal beat signal is generated corresponding to the plurality of objects; and
deriving an azimuth angle of the first object based on the difference of the first phase and an azimuth angle of the second object based on the difference of the second phase in a pair of the antennas.
